(19) United States
(12) Patent Application Publication
(10) Pub. No.: US 2018/0175992 A1
(43) Pub. Date: Jun. 21, 2018

(54) A Wireless Device, A Radio Network Node, And Methods Therein

(71) Applicant: Telefonaktiebolaget LM Ericsson (publ), Stockholm (SE)

(72) Inventors: Jonas Fröberg Olsson, Ljungsbro (SE); Andreas Bergström, Linköping (SE); Erik Eriksson, Linköping (SE); Pål Frenger, Linköping (SE); Martin Hessler, Linköping (SE)

(21) Appl. No.: 15/576,511

(22) PCT Filed: Jun. 17, 2015
(86) PCT No.: PCT/EP2015/063524

§ 371 Date: Nov. 22, 2017

(51) Int. Cl. H04L 5/00; H04W 24/10

(52) U.S. Cl. CPC H04L 5/0057; H04W 72/0446; H04L 5/0094; H04W 24/10

(57) ABSTRACT

A wireless device 130 and a method for performing Channel-State Information (CSI) measurements. The wireless device 130 and a Radio Network Node (RNN) 110 serving the wireless device 130 are operating in a wireless communications system 100. The wireless device 130 receives, from the RNN 110, information relating to a first resource for CSI measurement and an indication to determine a second resource for CSI measurement, which indication relates to the first resource for CSI measurement. Further, the wireless device 130 determines the second resource for CSI measurement based on the information relating to the first resource and on information comprised in the indication, which second resource for CSI measurement is different from the first resource for CSI measurement. Furthermore, the wireless device 130 performs an CSI measurement on the second resource.

### TECHNICAL FIELD

Embodiments herein relate generally to a wireless device, a radio network node and to methods therein. In particular they relate to performing Channel State Information (CSI) measurements.

### BACKGROUND

Communication devices such as terminals are also known as e.g. User Equipments (UE), mobile terminals, wireless devices, wireless terminals and/or mobile stations. Terminals are enabled to communicate wirelessly in a wireless communications network and/or cellular communication system, sometimes also referred to as a cellular radio system or cellular network. The communication may be performed e.g. between two terminals, between a terminal and a regular telephone and/or between a terminal and a server via a Radio Access Network (RAN) and possibly one or more core networks, comprised within the wireless communications network.

Terminals may further be referred to as mobile telephones, cellular telephones, laptops, or tablets with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area is served by a radio network node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated at the base station site, may serve one or several cells. Further, each base station may support one or several communication technologies. The base stations or radio nodes communicate over the air interface operating on radio frequencies with the communication devices, also denoted wireless devices, within range of the base stations or radio nodes. In the context of this disclosure, the expression Downlink (DL) is sometimes herein used for the transmission path from the radio node, e.g. a base station, to the wireless device. However, it should be understood that DL may sometimes herein be used for the transmission path from a node controlling the radio interface to the wireless device. The expression Uplink (UL) is used for the transmission path in the opposite direction i.e. from the wireless device to the radio node. Further, UL may sometimes be used for the transmission path from the wireless device to the node controlling the radio interface. The radio network node may in some circumstances, e.g. in systems enabling device-to-device (D2D) communications, also be realised by another wireless device. A transmission path in a D2D communication is a transmission path between two nodes, which nodes are not in control of the radio interface.

In many wireless communications networks, Channel-State Information (CSI) feedback is important in order to achieve good performance in the communications network. Reference signals are transmitted and used to estimate a channel state. Typically, the CSI feedback reported from a receiver to a transmitter of the Reference signal comprises a Channel-Quality Indicator (CQI) and/or a Rank Indicator (RI) value. More detailed reports may comprise a frequency-selective CQI value and/or a Pre-coding Matrix Indicator (PMI) value. For example, the CSI may relate to wideband CQI, wideband PMI, sub-band rank information such as frequency-selective rank information, sub-band CQI information such as frequency-selective CQI information, and/or sub-band PMI information such as frequency-selective PMI information.

The Third Generation Partnership Project (3GPP) for Long Term Evolution (LTE) system supports CSI reporting schemes that rely on periodic transmission of the reference signals, e.g. reference symbols. For example, the Cell-specific Reference Symbols (CRS) are sent on a subset of resource elements in the time-frequency grid every subframe, while the user-specific CSI Reference Symbols (RS) may be sent with a larger periodicity. Wireless devices, e.g. UEs, using the so-called Transmission Mode 10 (TM10) rely solely on CSI Reference Symbol (CSI-RS) measurement and CSI Interference Measurement (CSI-IM) resources while other wireless devices typically use the CRS at least for interference measurements. Herein, the terms “CSI measurement resource” and “resource for CSI measurement” are used interchangeably to refer to a set of resource elements used for a measurement related to CSI. For example, a CSI measurement resource may be the resource elements for CRS, a CSI-RS measurement resource or a CSI-IM resource. A CSI-RS measurement resource is identified by a CSI-RS configuration index and a CSI-IM resource is identified by a CSI-IM configuration index. The indices are sometime herein referred to as CSI configuration indices.

Wireless devices, e.g. UEs, using TM10 sometimes herein referred to as TM10 UEs, may be configured to report CSI for multiple CSI processes and each CSI process may have different CSI measurement resources. A CSI process for a UE using TM10 consists of two CSI measurement resources: one CSI-RS measurement resource used for channel estimation and a CSI-IM resource used for interference measurement. Each CSI configuration index identifies a CSI resource covering every Physical Resource Block (PRB) in the frequency band. A subframe configuration comprises a subframe periodicity and a subframe offset, which subframe periodicity and subframe offset specify for the UE at which time instances, i.e. at which points in time, the respective measurement resource will be available.

Mobile data traffic is growing exponentially due to the enormous success of wireless devices, such as smart phones, tablets and other data traffic appliances. The traditional way for increasing the data rate has been to increase the transmission bandwidth. However, the spectrum has become scarce due to the increase in wireless communications systems, and hence a challenge for the future wireless communications systems is to find alternative solutions to meet high demands on the data rate.

One option for handling the increased wireless data traffic is to deploy more radio network nodes, e.g. Base Stations (BS), and thereby densifying the wireless communications network, e.g. the cellular communications network. This would however increase interference and deployment cost.

Another option for increasing the data rate is to introduce large antenna arrays at the radio network node. Such an option is seemingly simpler in terms of deployment cost. The radio network node, having an excessive number of antennas, may simultaneously schedule multiple wireless devices, e.g. terminals, at the same time and/or frequency band with simple linear processing such as Maximum-Ratio Transmission (MRT) or Zero-Forcing (ZF) in the downlink and Maximum-Ratio Combining (MRC) or ZF in the uplink. This is often referred to as massive Multi-User (MU) Multiple-Input-Multiple-Output (MIMO), and is sometimes abbreviated as massive MIMO hereafter.

As mentioned above, future access technologies are expected to support a lot more transmit antennas, and especially then on the network side, e.g. at the radio network node. In the context of MIMO communications networks as an example, the number of antennas is expected to be huge. For example, a single transmission point, e.g. a radio network node, may have in the order of several hundreds or even thousands of antenna elements. A large, albeit much smaller, number of antennas may potentially be expected also in the wireless device, e.g. the UE. This may especially be the case for wireless devices at the high carrier frequencies, since the physical size of the antenna elements at those frequencies may be made very small.

The expected increased number of antenna elements, makes it possible to form more directive antenna patterns as compared to what is possible with the older antenna systems of today. The more capable communications system may focus its transmitted and/or received signal much more efficiently in a direction towards the wireless device being served, whilst suppressing the interference from and/or to other wireless devices. Each such direction is typically referred to as a ‘beam’, whereas the entire process is referred to as ‘beam-forming’.

Antenna beamforming is a technique of shaping the transmit radiated energy pattern or the receive sensed energy pattern into beams by the use of an antenna element array. The antenna elements are typically closely spaced with for example respect to the wavelength, or equivalently to the carrier frequency used for the wireless communication, e.g. the radio communication. These beams may be used to concentrate the transmitted signal energy and/or received signal energy and/or steer it in specific directions. FIG. 1 depicts a classic example wherein a linear antenna array is used to steer the beam an angle ω off-axis compared to the orientation of the antenna array. In order for the waveforms from two antenna elements to superimpose constructively in that direction, the phase rotation difference of the two signals due to the path distance difference Δ must correspond to an integer multiple of 2π. This requirement leads to an expression for the phase angle or phase delay φ that is a function of a steering angle, an array element distance, and a wavelength.

FIG. 1 schematically illustrates basic beamforming using a one-dimensional linear array, wherein d is the array element distance, ω the desired beam steering angle,

$$ϕ = \frac{2 π d \cdot sin ( ω )}{λ}$$

the required phase delay, and λ is the wavelength. Typically d≈λ/2.

When used herein the term ‘beam’ is used to refer to a certain spatial transmit radiation pattern or spatial receive sensitivity pattern created by using a combination of multiple antenna elements and the corresponding complex-valued weights applied to the signal at each antenna element.

As mentioned above, the number of transmit antennas is expected to increase, and as the state of the art requires measurement of more and more beam directions when the number of transmit antennas increases, the state of the art results in an increased overhead of signalling relating to such measurements in the wireless communications system.

### SUMMARY

Therefore, an object of embodiments herein is to provide a way of improving the performance in a wireless communications system.

According to a first aspect of embodiments herein, the object is achieved by a method performed by a wireless device for performing Channel-State Information (CSI) measurements. The wireless device and a Radio Network Node (RNN) serving the wireless device are operating in a wireless communications system.

The wireless device receives, from the RNN, information relating to a first resource for CSI measurement.

Further, the wireless device receives, from the RNN, an indication to determine a second resource for CSI measurement. The indication relates to the first resource for CSI measurement.

Furthermore, the wireless device determines the second resource for CSI measurement based on the information relating to the first resource and on information comprised in the indication. The second resource for CSI measurement is different from the first resource for CSI measurement.

Yet further, the wireless device performs an CSI measurement on the second resource.

According to a second aspect of embodiments herein, the object is achieved by a wireless device for performing Channel-State Information (CSI) measurements. The wireless device and a Radio Network Node (RNN) serving the wireless device are configured to operate in a wireless communications system.

The wireless device is configured to receive, from the RNN, information relating to a first resource for CSI measurement.

Further, the wireless device is configured to receive, from the RNN, an indication to determine a second resource for CSI measurement. The indication relates to the first resource for CSI measurement.

Furthermore, the wireless device is configured to determine the second resource for CSI measurement based on the information relating to the first resource and on information comprised in the indication. The second resource for CSI measurement is different from the first resource for CSI measurement.

Yet further, the wireless device is configured to perform an CSI measurement on the second resource.

According to a third aspect of embodiments herein, the object is achieved by a method performed by a Radio Network Node (RNN) for assisting a wireless device in performing Channel State Information (CSI) measurement. The wireless device and the RNN serving the wireless device are configured to operate in a wireless communications system.

The RNN determines a first resource for CSI measurement and transmits, to the wireless device, information relating to the first resource for CSI measurement.

Further, the RNN determines an indication to determine a second resource for CSI measurement. The indication relates to the first resource for CSI measurement and the second resource for CSI measurement is different from the first resource for CSI measurement.

Furthermore, the RNN transmits, to the wireless device, the indication to determine the second resource for CSI measurement.

According to a fourth aspect of embodiments herein, the object is achieved by a Radio Network Node (RNN) for assisting a wireless device in performing Channel State Information (CSI) measurement. The wireless device and the RNN serving the wireless device are operating in a wireless communications system.

The RNN is configured to determine a first resource for CSI measurement, and to transmit, to the wireless device, information relating to the first resource for CSI measurement.

Further, the RNN is configured to determine an indication to determine a second resource for CSI measurement. The indication relates to the first resource for CSI measurement and the second resource for CSI measurement is different from the first resource for CSI measurement.

Furthermore, the RNN is configured to transmit, to the wireless device, the indication to determine the second resource for CSI measurement.

According to a fifth aspect of embodiments herein, the object is achieved by a computer program, comprising instructions which, when executed on at least one processor, causes the at least one processor to carry out the method performed by the wireless device.

According to a sixth aspect of embodiments herein, the object is achieved by a computer program, comprising instructions which, when executed on at least one processor, causes the at least one processor to carry out the method performed by the RNN.

According to a seventh aspect of embodiments herein, the object is achieved by a carrier comprising the computer program, wherein the carrier is one of an electronic signal, an optical signal, a radio signal or a computer readable storage medium.

Since the wireless device receives information relating to the first resource for CSI measurements and an indication to determine a second resource for CSI measurement, which indication relates to the first resource for CSI measurement, and since the wireless device determines the second resource for CSI measurement based on the information relating to the first resource and on information comprised in the indication, which second resource for CSI measurement is different from the first resource for CSI measurement, the wireless device is able to perform an CSI measurement on the second resource, whereby the reference signal overhead for performing CSI measurement in the wireless communications system is reduced. This results in an improved performance in the wireless communications system.

The reference signal overhead is herein sometimes referred to as an overhead in reference signaling or an overhead of reference signaling.

An advantage with embodiments herein is an improved support for CSI measurements in a wireless communications system comprising a large number of antennas.

Another advantage with embodiments herein is that they provide a wireless communication system having a higher user throughputs, lower packet delays, and enhanced system capacity as compared to the wireless communications systems of today

Yet another advantage with embodiments herein is that the wireless communications system, e.g. the RNN, may multiplex multiple beams on the same first CSI measurement resource by instructing groups of wireless devices, e.g. user equipments, to measure CSI on different second CSI resources. For example, the RNN may instruct each group in one beam to measure CSI on an own second CSI resource. Hence, more beams may be fit-in during a measurement time period.

### BRIEF DESCRIPTION OF DRAWINGS

Examples of embodiments herein are described in more detail with reference to attached drawings in which:

FIG. 1 schematically illustrates beam forming using a one-dimensional linear antenna array;

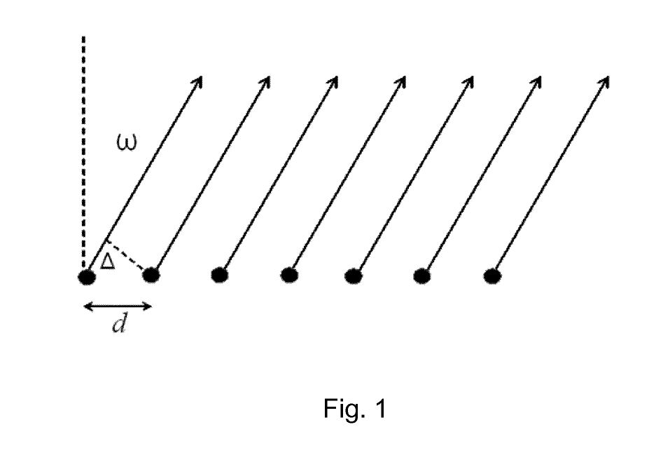

FIG. 2 schematically illustrates an embodiment of a wireless communications system;

FIG. 3 is a schematic combined flowchart and signalling scheme of embodiments of methods performed in a wireless communications system;

FIG. 4 is a flowchart depicting embodiments of a method performed by a wireless device;

FIG. 5 is a schematic block diagram illustrating embodiments of a wireless device;

FIG. 6 is a flowchart depicting embodiments of a method performed by a radio network node;

FIG. 7 is a schematic block diagram illustrating embodiments of a radio network node;

FIG. 8A schematically illustrates a first exemplifying PRB bitmap CSI measurement configuration comprising a first resource for CSI measurement;

FIG. 8B schematically illustrates a first exemplifying PRB bitmap CSI measurement configuration comprising first and second second resource for CSI measurement;

FIG. 9 schematically illustrates a second exemplifying PRB bitmap CSI measurement configuration; and

FIG. 10 schematically illustrates a third exemplifying PRB bitmap CSI measurement configuration.

### DETAILED DESCRIPTION

As part of developing embodiments herein, some problems with the state of the art communications systems will first be identified and discussed.

It is known that when an antenna panel size increases, the channel for a single beam-direction becomes more and more frequency flat, e.g. it will comprise a single propagation path, sometimes referred to as a 1-tap channel.

This is related to what in Massive MIMO is denoted channel hardening which also implies that the channel shows less frequency-selective variations after a proper choice of pre-coder. This is in principal due to that the diversity and/or directivity of the transmitted signal increases, which is enabled by the increased number of antennas. However, it is still fundamentally different as many pre-coders will transmit over multiple paths.

Hence, for a single narrow beam, the number of resources required to acquire sufficient channel estimation accuracy is expected to be lower as the number of antennas increases, hence current CSI-RS measurement resources and/or CSI-IM resources will give a too high overhead signaling. However, interference may still be frequency selective since it highly depends on how other wireless devices are scheduled in frequency and hence, for example, which pre-coders are used in different resources.

Today, several problems related to the current CSI measurement resources used in the state of the art communications systems exist.

Firstly, the CSI measurement resource is inflexible in that the CSI configuration index identifies a fixed set of resource elements to be used for CSI measurements, and which resource elements are spread over a frequency band allocated for the wireless communications system. Thus, it is not possible to use other CSI measurement resources and/or only a part of the allocated frequency band.

Secondly, the CSI measurement resource is not scalable. In other words, the total amount of available CSI measurement resources is fixed within an CSI measurement resource subframe. Thus, if for example four symbols are available as CSI measurement resources within the CSI measurement resource subframe, the number of CSI measurement resources within the CSI measurement resource subframe cannot be extended to be for example eight symbols if more CSI measurements are needed.

Thirdly, a CSI-RS measurement resource and a CSI-IM resource are coupled in the sense that both measure over the whole frequency band. Thus, they both define measurements over all PRBs within the CSI measurement resource subframe.

As previously mentioned, in future wireless communications systems the number of potential antenna beam forming directions will increase rapidly, which makes it necessary to measure more and more beam directions causing an increased reference signal overhead in the wireless communications system, which reference signal overhead is due to that more beams require more reference signals.

Therefore, according to embodiments herein, a way of improving the performance in a wireless communications system is provided.

Some embodiments herein enable an enhanced multi-antenna support by means of CSI extensions, such as splitting and moving of one or more CSI measurement resource. As previously mentioned, the term CSI measurement resource refers to a set of resource elements used for a measurement related to CSI. Such a resource element is sometimes herein referred to as a CSI measurement resource element. Further, the term CSI measurement resource when used herein may refer to the set of resource elements in a time-frequency grid belonging to the CSI measurement resource. Such resource element in a time-frequency grid is determined by a sub-carrier in an Orthogonal Frequency Division Multiplexing (OFDM) symbol.

Thus, some embodiments herein extend the current CSI measurement mappings by means of splitting or moving an existing CRI measurement resource. Before describing what is meant by CSI measurement mapping it should be understood that a CSI measurement reference signal is a signal comprising a sequence of symbols, e.g. CSI measurement reference symbols. By mapping is meant the method describing on which CSI measurement resource element each one of the symbols comprised in the sequence of CSI measurement reference symbols should be sent. Therefore, some embodiments herein, comprising one or more of the exemplifying CSI measurement extensions and/or port-mapping examples disclosed herein, enable enhanced multi-antenna support.

As will be described below, splitting of an CSI measurement resource may be done as a sub-sampling in the frequency domain. This may be expressed by a bit-map; a sub-sampling factor and an offset; an index to a predefined table comprising several, e.g. all, defined sub-samplings; etc.

For example, by a bit-map such as a Physical Resource Block (PRB) bitmap, the CSI-RS resource may be split into potentially N times more CSI measurement resources, where N is the number of physical resource blocks of the frequency band.

As a further example, by a sub-sampling factor of 2, a first CSI measurement resource may be split into two CSI measurement resources, which two CSI measurement resources sometimes herein is referred to as a second CSI measurement resource. However, such a second CSI measurement resource may sometimes be considered as comprising several parts of CSI measurement resources. In the example give above, wherein the first CSI measurement resource was spilt into two parts, the second CSI measurement resource comprises a first second CSI measurement resource of e.g. PRBs 0, 2, 4, etc., and a second second CSI measurement resource of e.g. PRBs 1, 3, etc. An offset may determine which part of the second CSI measurement resource that is the first second CSI measurement resource and which part is the second second CSI measurement resources.

As a yet further example, an index 0 may mean or refer to the first second CSI measurement resource and an index 1 may mean or refer to the second second CSI measurement resource.

The CSI measurement resource splitting may also be performed in the code domain where a code spread is performed over the resource elements used for an existing CSI measurement resource, e.g. a legacy CSI measurement resource such as a CSI-RS measurement resource or a CSI-IM resource, in order to create two or more new CSI measurement resources. The CSI measurement resource may be logically split into two or more CSI measurement resources. By logically is herein meant that CSI measurement resource elements for the two CSI measurement resources are the same, but the signals sent on the CSI measurement resource elements and defining the measurement resource are different. This may be accomplished by that the sequence of CSI measurement symbols are scrambles by e.g. two different orthogonal cover codes covering multiple PRBs. A first half of ports may then be associated by a first orthogonal cover code, while the other half is associated by the other orthogonal cover code.

One example of code spreading is applying different orthogonal cover codes, whereby the existing CSI measurement resource is split into a larger number of possible ports by coding over multiple PRBs.

CSI measurement resources may also be extended by means of moving an existing CSI measurement resource in time, e.g. to one or more new symbols within a sub-frame. Further, it will be exemplified below how a combination of legacy CSI measurement resources, e.g. non-shifted CSI measurement resources, and of extended CSI measurement resources, e.g. time-shifted CSI measurement resources, may enable the use of sixteen (16) antenna ports.

Below, embodiments herein will be illustrated in more detail by a number of exemplary embodiments. It should be noted that these embodiments are not mutually exclusive. Components from one embodiment may be tacitly assumed to be present in another embodiment and a person skilled in the art will realize how those components may be used in the other exemplary embodiments.

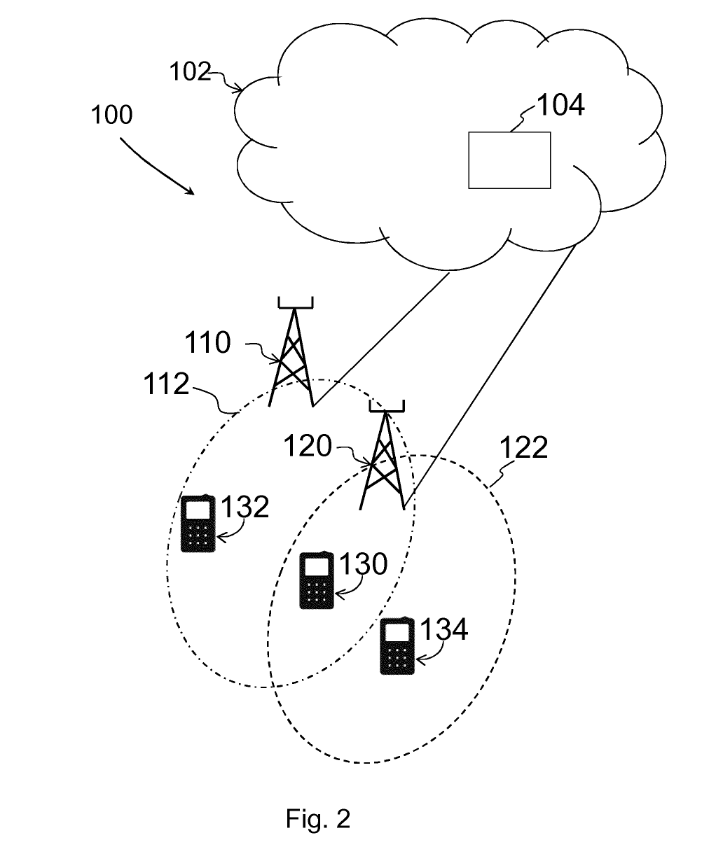

As schematically illustrated in FIG. 2 embodiments herein relate to a wireless communications system 100, such as a wireless communications network or a cellular communications network. The wireless communications system 100 may be an LTE network, a WCDMA network, an GSM network, any 3GPP cellular network, Wimax, or any other wireless communications network or system.

A core network 102 may be comprised in the wireless communications system 100. The core network 102 may be an LTE Core network, e.g. a System Architecture Evolution (SAE) network, a WCDMA core network, an GSM core network, any 3GPP cellular core network, a Wimax core network, or any other wireless communications core network or system.

Further, a core network node 104 may be comprised in the wireless communications system 100. The core network node 104 may be an LTE core network node, a WCDMA core network node, an GSM core network node, any 3GPP cellular core network node, a Wimax core network node, or any other wireless communications core network or system node.

A Radio Network Node (RNN) 110 is comprised in the wireless communications system 100. The RNN 110 may herein sometimes be referred to as a first RNN. The RNN 110 is configured for wireless communication with one or more wireless devices, such as a wireless device 130, when they are located within a geographical area 112 served by the RNN 110.

A second Radio Network Node (RNN) may be configured to operate in the wireless communications system 100. The second RNN may sometimes herein be referred to as an interfering RNN 120. By the expression “interfering RNN” when used herein is meant a second RNN that transmits one or more signals, which one or more signal cause interference to one or more wireless devices receiving signals from the first RNN 110.

The second RNN is configured for wireless communication with one or more wireless devices, such as the wireless device 130, when they are located within a geographical area 122 served by the second RNN.

The RNN 110 and/or the interfering RNN 120 may be a transmission point such as a radio base station, for example an eNodeB, also denoted eNB, a Home eNodeB, or a NodeB or any other network node capable to serve a wireless device, e.g. a user equipment or a machine type communication device in a wireless communications system, such as the wireless communications system 100. In case of device-to-device (D2D) communication providing e.g. CSI measurement, the RNN 110 and/or the interfering RNN 120 may be a wireless device. In such embodiments, the wireless device 130 may be referred to as a first wireless device and the RNN 100 and/or the interfering RNN 120 may be referred to as a second wireless device, or vice versa.

One or more other wireless devices 132,134 may be served by the RNN 110 and/or the interfering RNN 120, when they are located within the geographical area 112,122 served by the RNN 110 and the interfering RNN 120, respectively.

Sometimes herein the wireless device 130 may be referred to as a first wireless device 130 and the one or more wireless devices 132,134 may be referred to as one or more second wireless devices 132,134.

The wireless device, e.g. the wireless device 130,132,134, herein also referred to as a user equipment or UE, operates in the wireless communications system 100. The wireless device 130,132,134 may e.g. be a user equipment, a mobile terminal or a wireless terminal, a mobile phone, a computer such as e.g. a laptop, a Personal Digital Assistant (PDA) or a tablet computer, sometimes referred to as a tablet, with wireless capability, or any other radio network unit capable of communicating over a radio link in the wireless communications system 100. Please note that the term user equipment used in this document also covers other wireless devices such as Machine-to-Machine (M2M) devices, even though they may not have any user.

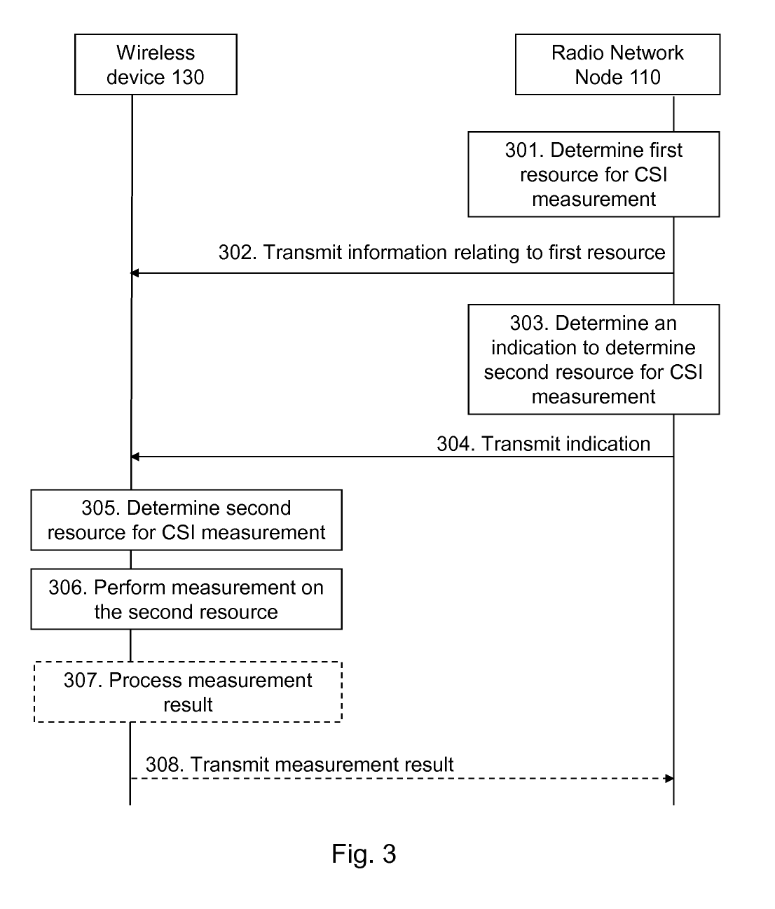

Methods performed by the wireless communications system 100 for performing CSI measurements will now be described with reference to a combined flowchart and signalling scheme depicted in FIG. 3. As previously described, the wireless device 130 and the RNN 110 serving the wireless device 130 are operating in the wireless communications system 100.

The methods comprise one or more of the following actions. It should be understood that actions may be taken in any suitable order and that actions may be combined.

Action 301

The RNN 110 determines a first resource for CSI measurement. The first resource for CSI measurement is herein sometimes denoted R1. In other words, the RNN 110 determines a first CSI measurement resource to be used by a wireless device, e.g. the wireless device 130, when for example determining a second resource for CSI measurements, as will be described in relation to Action 305 below.

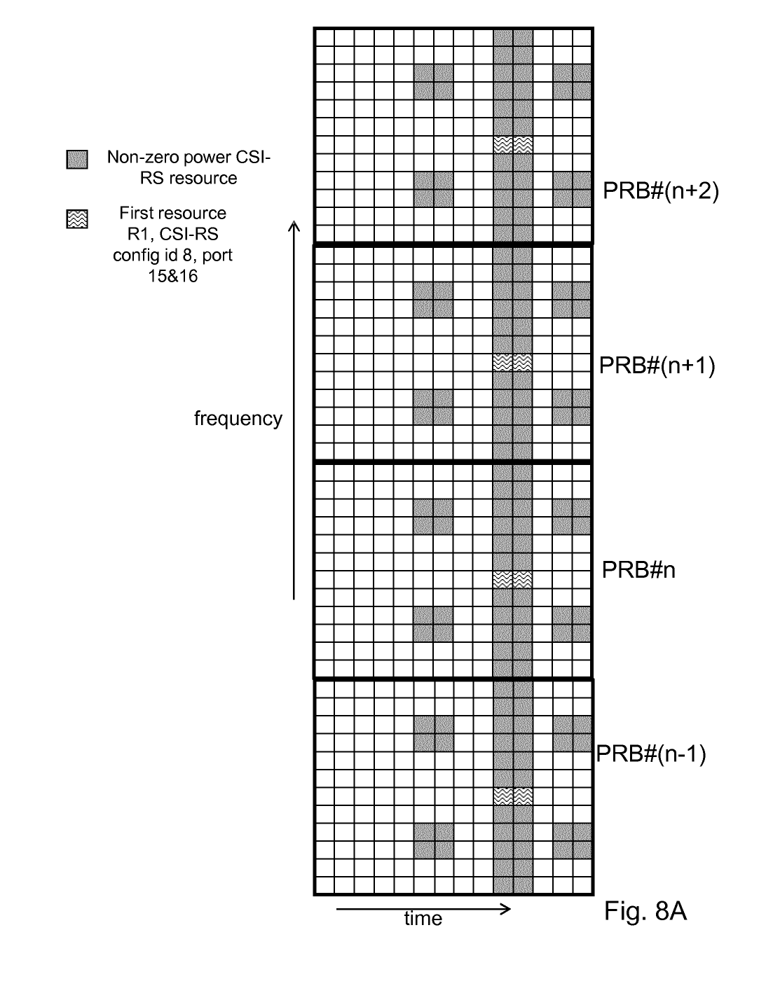

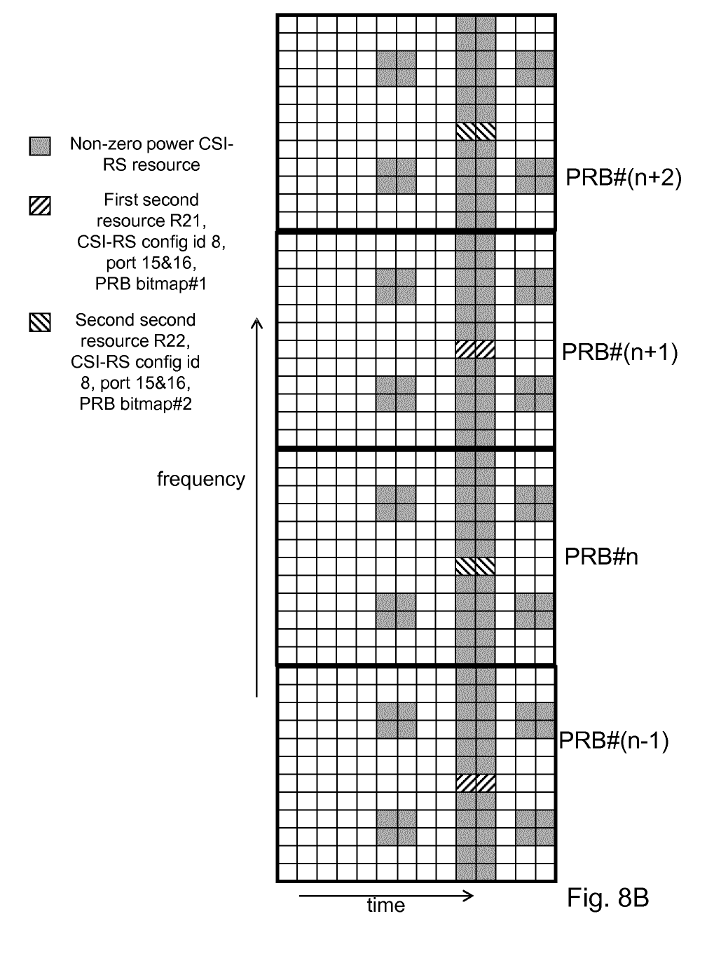

FIG. 8A, which will be described in more detail below, schematically illustrates a first resource R1 for CSI measurement.

Action 301 relates to Action 601 which will be described below.

Action 302

The RNN 110 transmits, to the wireless device 130, information relating to the first resource for CSI measurement. Thereby, the wireless device 130 will receive information relating to the first resource which first resource may be used when the wireless device 130 determines the second resource for CSI measurements. For example, the information may define and/or identify the first resource for CSI measurement. Thus, the information may comprise an identification of the first resource for CSI measurement, information about or relating to one or more resource elements used for a CSI measurement on the first resource, and/or information about the kind of CSI measurement.

The second resource for CSI measurement is herein sometimes denoted R2.

For example, the first and second resources for CSI measurement may be first and second CSI Reference Symbol (CSI-RS) measurement resources, or first and second CSI Interference Measurement (CSI-IM) resources.

As previously described, a CSI measurement resource may be a CSI-RS measurement resource or a CSI-IM resource. Further, in some embodiments, the second resource for CSI measurement may comprise a first second resource for CSI measurement and a second second resource for CSI measurement. In such embodiments, the first and second second resources for CSI measurement may comprise one or more CSI-RS measurement resources or one or more CSI-IM resources.

However, for simplicity and since embodiments herein are equally applicable to a CSI-RS measurement resource and a CSI-IM resource, we will herein refer to a first resource for CSI measurement and a second resource for CSI measurement, respectively, which first and second resources for CSI measurement may be first and second CSI-RS measurement resources, or first and second CSI-IM resources as described above.

Action 302 relates to Action 602 which will be described below.

Action 303

The RNN 110 determines an indication to determine a second resource for CSI measurement. The indication relates to the first resource for CSI measurement. Further, the second resource for CSI measurement is different from the first resource for CSI measurement.

For example, the RNN 110 may determine the indication to determine the second resource for CSI measurement, when the RNN 110 has determined that it would be beneficial to extend the current CSI measurement resource mapping by means of splitting or moving an existing CSI measurement resource, e.g. the first resource for CSI measurement. One example of when it would be beneficial to extend the current CSI measurement resource mapping is when the number of antennas at the RNN 110 is large, e.g. larger than for example 8. With more antenna elements more ports are needed for CSI to be related to each antenna element. Another example is when it is expected that the channel has a coherence bandwidth significantly larger than 1 PRB, which may be the case when delay-spread of the channel is small, often seen e.g. in indoor deployments or line-of-sight.

With reference to FIGS. 8A and 8B, which will be described in more detail below, the first resource R1 for CSI measurement is schematically illustrated in FIG. 8A, and a second resource R2 for CSI measurement is schematically illustrated in FIG. 8B. Especially, FIG. 8B schematically illustrates two second resources for CSI measurement; a first second resource R21 and a second second resource R22. This may be the result when the first resource R1 of FIG. 8A has been split into two resources.

Action 303 relates to Actions 603 which will be described below.

Action 304

The RNN 110 transmits, to the wireless device 130, the indication to determine the second resource for CSI measurement. Thereby, the wireless device 130 may be instructed to determine the second resource for CSI measurement in accordance with the indication. The indication may comprise information relating to a resource for CSI measurement that the RNN 110 prefers the wireless device 130 to determine and use.

Further, the indication may be transmitted from the RNN 110 to the wireless device 130 by means of a Radio Resource Control (RRC) protocol, a Medium Access Control (MAC) such as a MAC control element.

Furthermore, the indication may be transmitted from the RNN 110 to the wireless device 130 by means of a combination of RRC and Downlink Control Information (DCI) transmitted on a control channel, e.g. on a Physical Downlink Control Channel (PDCCH), wherein the wireless device 130 may be pre-configured using RRC with two or more alternative “sub-sampling” alternatives, and the actual used sub-sampling is indicated in the DCI.

A similar combination may be RRC and MAC, where the actual used sub-sampling is indicated in a MAC control element.

Action 304 relates to Action 604 which will be described below.

Action 305

The wireless device 130 determines the second resource for CSI measurement based on the information relating to the first resource and on information comprised in the indication, which second resource for CSI measurement is different from the first resource for CSI measurement.

For example, the second resource for CSI measurement may be different from the first resource for CSI measurement from a logical point. That means that the second resource may map to the same subset of the physical resources as the first resource maps to, but that the physical signal associated with the second resource is different, e.g. that second CSI measurement symbols are scrambled using a second orthogonal cover code that is different from a first orthogonal cover code with which the first CSI measurement symbols are scrambled. In other cases, the second resource for CSI measurement may be different from the first resource for CSI measurement in that the first and second resources may be mapped to separate physical resources, i.e. the sets of resource elements for the first and second resources are not the same set. Further, the first and second resources may be considered as different in terms of time, frequency and/or code used to map the signal.

Action 305 relates to Action 403 which will be described below. In Action 403 it will be described in more detail how the two resource for CSI measurements may be different.

Action 306

The wireless device 130 performs an CSI measurement on the second resource. As will be described below, the CSI measurement may be a CSI Reference Symbol (RS) measurement or a CSI Interference Measurement (IM).

Action 306 relates to Action 404 which will be described below.

Action 307

In some embodiments, the wireless device 130 processes the result of the performed CSI measurement. For example, the wireless device 130 may process the result by performing signal processing to obtain channel estimates and/or interference estimates. Such signal processing may be followed by matrix computations of channel and interference estimates to obtain a CSI report, which report may comprise information relating to the RI, CQI and/or PMI.

Action 308

In some embodiments, the wireless device 130 transmits the result of the of the performed CSI measurement to one or more network nodes, e.g. to the RNN 110. The transmitted result may be unprocessed or processed as described in Action 307 above before transmitted to the one or more network nodes. Further, the wireless device 130 may transmit the result using one or more of a RRC protocol, MAC, and DCI as described above.

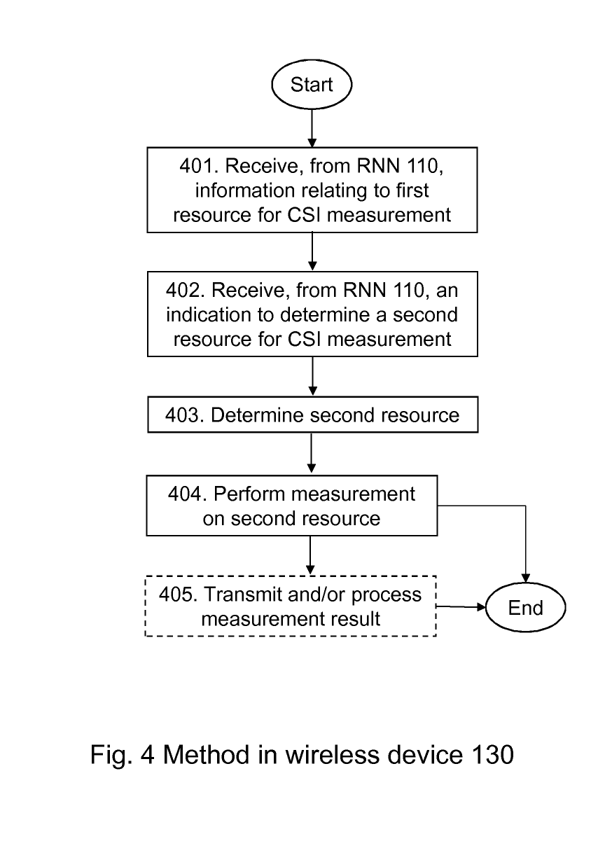

Methods performed by the wireless device 130 for performing CSI measurements, will now be described with reference to the flow chart depicted in FIG. 4. As previously described, the wireless device 130 and the RNN 110 serving the wireless device 130 are operating in the wireless communications system 100.

The method comprises one or more of the following actions. It should be understood that actions may be taken in any suitable order and that actions may be combined.

Action 401

The wireless device 130 receives, from the RNN 110, information relating to a first resource for CSI measurement.

For example and as previously mentioned, the information may define and/or identify the first resource for CSI measurement. Thus, the information may comprise an identification of the first resource for CSI measurement, information about or relating to one or more resource elements used for a CSI measurement on the first resource, and/or information about the kind of CSI measurement.

As also previously described, the first resource for CSI measurement may be a first CSI RS measurement resource, or a first CSI IM resource. In other words, the first resource for CSI measurement may be a resource for performing a CSI RS measurement or a CSI IM.

Action 401 relates to Action 302 previously described.

Action 402

The wireless device 130 receives, from the RNN 110, an indication to determine a second resource for CSI measurement. The indication relates to the first resource for CSI measurement.

In some embodiments, the indication relates to the first resource in that it comprises information about the first resource such as information about or relating to one or more resource elements used for a CSI measurement on the first resource, and/or the kind of CSI measurement.

The indication may comprise information relating to one or more PRBs to be used by the wireless device 130 when determining the second resource.

For example, and as previously described, the second resource for CSI measurement may be a second CSI RS measurement resource, or a second CSI IM resource. In other words, the second resource for CSI measurement may be a resource for performing a CSI RS measurement or a CSI IM.

In some embodiments, the indication to determine the second resource for CSI measurement may be referred to as an indication to construct the second resource for CSI measurement.

Action 402 relates to Action 304 previously described.

Action 403

The wireless device 130 determines the second resource for CSI measurement based on the information relating to the first resource and on information comprised in the indication. The second resource for CSI measurement is different from the first resource for CSI measurement.

For example and as previously described, the second resource for CSI measurement may be different from the first resource for CSI measurement from a logical point. That means that the second resource may map to the same subset of the physical resources as the first resource maps to, but that the physical signal associated with the second resource is different, e.g. that second CSI measurement symbols are scrambled using a second orthogonal cover code that is different from a first orthogonal cover code with which the first CSI measurement symbols are scrambled. In other cases, the second resource for CSI measurement may be different from the first resource for CSI measurement in that the first and second resources may be mapped to separate physical resources, i.e. the sets of resource elements for the first and second resources are not the same set. Further, the first and second resources may be considered as different in terms of time, frequency and/or code used to map the signal.

In some embodiments, the wireless device 130 determines the second resource for CSI measurement based on the information relating to the first resource and on information comprised in the indication by determining the second resource for CSI measurement as a frequency sub-sampling, a time sub-sampling, a code sub-sampling, a time offset and/or a frequency offset of the first resource for CSI measurement.

In some alternative embodiments, the wireless device 130 determines the second resource for CSI measurement based on the information relating to the first resource and on information comprised in the indication by determining the second resource for CSI measurement as a combination of two or more first resources for CSI measurements.

In some further alternative embodiments, the wireless device 130 determines the second resource for CSI measurement based on the information relating to the first resource and on information comprised in the indication by determining the second resource for CSI measurement based on information relating to one or more Physical Resource Blocks (PRBs) which information is comprised in the received indication.

In some embodiments, wherein the indication to determine the second resource for CSI measurement is referred to as an indication to construct the second resource for CSI measurement, it may be referred to as the wireless device 130 constructs the second resource for CSI measurement based on the information relating to the first resource and on information comprised in the indication.

Action 403 relates to Action 305 previously described.

Action 404

The wireless device 130 performs an CSI measurement on the second resource. As previously described, the wireless device 130 may perform a CSI RS measurement or a CSI IM.

Action 404 relates to Action 306 previously described.

Action 405

In some embodiments, the wireless device 130 processes the result of the CSI measurement and/or transmits the result of the CSI measurement to one or more network nodes, e.g. to the RNN 110 or to a core network node.

Action 405 relates to Actions 307 and 308 previously described.

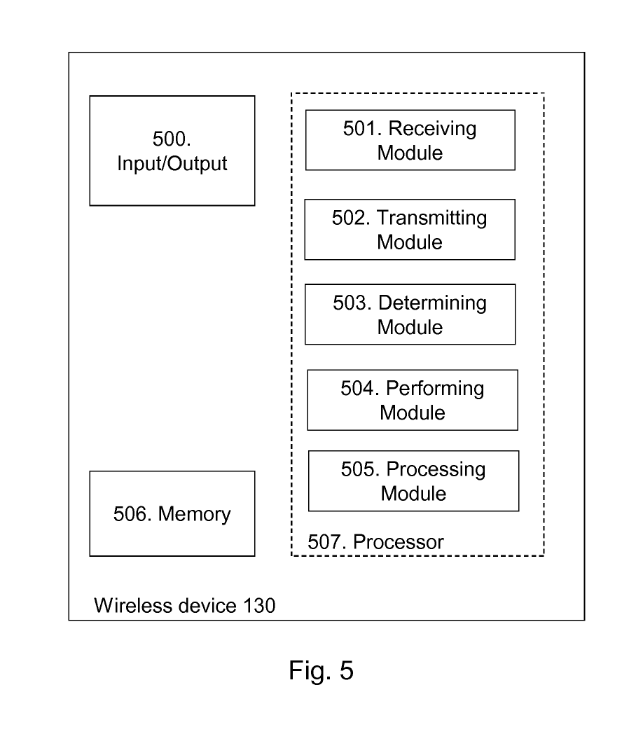

To perform the methods for performing CSI measurements, the wireless device 130 may comprise an arrangement depicted in FIG. 5. As previously described, the wireless device 130 and the RNN 110 serving the wireless device 130 are configured to operate in the wireless communications system 100.

In some embodiments, the wireless device 130 comprises an input and/or output interface 500 configured to communicate with one or more wireless devices, one or more radio nodes, such as the RNN 110,120, and one or more other network nodes. The input and/or output interface 500 may comprise a wireless receiver (not shown) and a wireless transmitter (not shown).

The wireless device 130 is configured to receive, e.g. by means of a receiving module 501 being configured to receive, from the RNN 110, information relating to a first resource for CSI measurement. The receiving module 501 may be implemented by the wireless receiver or by a processor 507 of the wireless device 130. The processor 507 will be described in more detail below.

In some embodiments, the information relating to the first resource for CSI measuring may be considered as received from the RNN 110 during for example configuration of the wireless device 130. This may also be expressed as the wireless device 130 obtains the information from the RNN 110.

The wireless device 130 is further configured to receive, e.g. by means of the receiving module 501 being configured to receive, from the RNN 110, an indication to determine a second resource for CSI measurement. The indication relates to the first resource for CSI measurement.

For example, the first resource for CSI measurement may be a first CSI RS measurement resource, or a first CSI IM resource, and the second resource for CSI measurement may be a second CSI RS measurement resource, or a second CSI IM resource.

In some embodiments, the first and second resources for CSI measurement is a respective first and second CSI RS measurement resource.

In some alternative embodiments, the first and second resources for CSI measurement is a respective first and second CSI IM resource.

The wireless device 130 is configured to transmit, e.g. by means of a transmitting module 502 being configured to transmit, data or information to one or more wireless devices, one or more radio nodes, such as the RNN 110,120, and one or more other network nodes. The transmitting module 502 may be implemented by the wireless transmitter or the processor 507 of the wireless device 130.

In some embodiments, the wireless device 130 is configured to transmit the result of a performed CSI measurement to a network node such as the RNN 110.

The wireless device 130 may be configured to determine, e.g. by means of a determining module 503 being configured to determine, the second resource for CSI measurement based on the information relating to the first resource and on information comprised in the indication. The second resource for CSI measurement is different from the first resource for CSI measurement. The determining module 503 may be implemented by the processor 507 of the wireless device 130.

As previously mentioned, the second resource for CSI measurement may be different from the first resource for CSI measurement from a logical point.

In some embodiments, the wireless device 130 is configured to determine the second resource for CSI measurement based on the information relating to the first resource and on information comprised in the indication by further being configured to determine the second resource for CSI measurement as a frequency sub-sampling, a time sub-sampling, a code sub-sampling, a time offset and/or a frequency offset of the first resource for CSI measurement.

In some alternative embodiments, the wireless device 130 is configured to determine the second resource for CSI measurement based on the information relating to the first resource and on information comprised in the indication by further being configured to determine the second resource for CSI measurement as a combination of two or more first resources for CSI measurements.

In some alternative embodiments, the wireless device 130 is configured to determine the second resource for CSI measurement based on the information relating to the first resource and on information comprised in the indication by further being configured to determine the second resource for CSI measurement based on information relating to one or more PRBs which information is comprised in the received indication.

The wireless device 130 is configured to perform, e.g. by means of a performing module 504 being configured to perform, an CSI measurement on the second resource. The performing module 504 may be implemented by the processor 507 of the wireless device 130.

In some embodiments, the wireless device 130 is configured to process, e.g. by means of a processing module 505 being configured to process, the result of the performed CSI measurement. The processing module 505 may be implemented by the processor 507 of the wireless device 130.

The wireless device 130 may also comprise means for storing data. In some embodiments, wireless device 130 comprises a memory 506 configured to store the data. The data may be processed or non-processed data and/or information relating thereto. The memory 506 may comprise one or more memory units. Further, the memory 506 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the wireless device 130.

Embodiments herein for performing CSI measurements may be implemented through one or more processors, such as the processor 507 in the arrangement depicted in FIG. 5, together with computer program code for performing the functions and/or method actions of embodiments herein. The program code mentioned above may also be provided as a computer program product, for instance in the form of a data carrier carrying computer program code for performing the embodiments herein when being loaded into the wireless device 130. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the wireless device 130.

Those skilled in the art will also appreciate that the receiving module 501, the transmitting module 502, the determining module 503, the performing module 504, and the processing module 505 above may refer to a combination of analog and digital circuits, and/or one or more processors configured with software and/or firmware, e.g. stored in the memory 506, that when executed by the one or more processors such as the processors in the wireless device 130 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

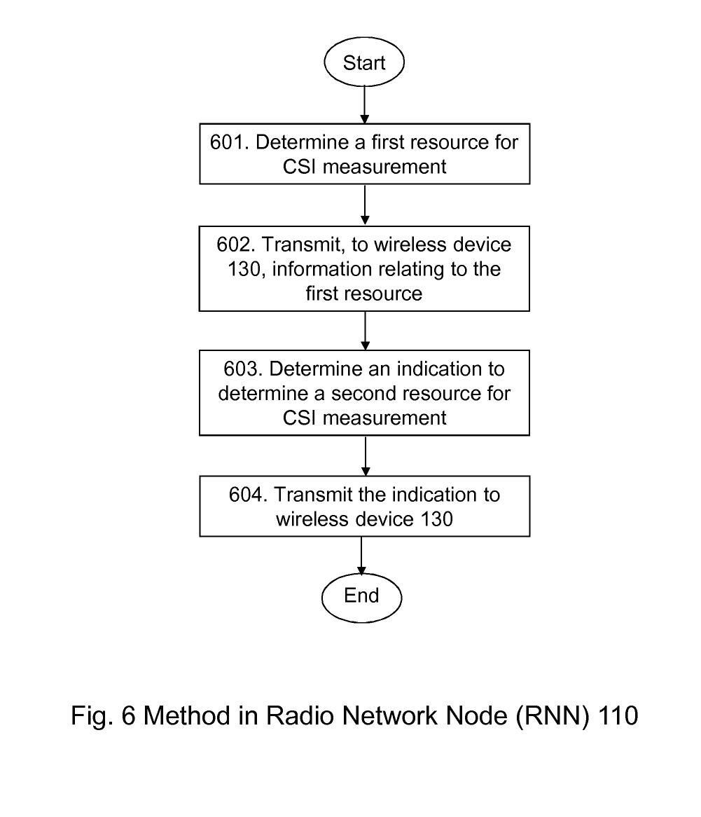

Methods performed by the RNN 110 for assisting the wireless device 130 in performing CSI measurements, will now be described with reference to the flow chart depicted in FIG. 6. As previously described, the wireless device 130 and the RNN 110 serving the wireless device 130 are operating in the wireless communications system 100.

The method comprises one or more of the following actions. It should be understood that actions may be taken in any suitable order and that actions may be combined.

Action 601

The RNN 110 determines a first resource for CSI measurement.

For example and as previously mentioned, the first resource for CSI measurement may be a first CSI RS measurement resource, or a first CSI IM resource.

In some embodiments, the RNN 110 determines the first resource for CSI measurement to correspond to one or more of: a CSI resource determined as being used in the interfering RNN 120; an available first resource for CSI measurement; an CSI resource determined as not being used by one or more other wireless devices 132,134; and an CSI resource determined to be used by one or more other wireless devices 132,134. For example, there may be a group of wireless devices, e.g. one or more wireless devices, in a beam using a CSI resource for their CSI measurement. It may also be desired that the wireless device, e.g. the wireless device 130, for which the RNN 110 shall determine the CSI resource for is served within said beam. Therefore the RNN 110 determines to use the CSI resource used by the wireless devices in the group. The one or more other wireless devices 132,134 may be grouped with respect to radio conditions, such as pathloss, interference, receiver sensitivity, transmitter power, capability of the wireless device, number of antennas associated with the wireless device, vendor of the wireless device, etc. It should be understood that term radio condition may comprise everything that impact the radio signal sent from the RNN to the wireless device such as how fast the wireless device is moving, fading, e.g., scattering, houses, trees, moving cars in the way of radio signal, etc. Thus, the one or more other wireless devices 132,134 may belong to a group being served by a common beam and having the same or similar pathloss when communicating with the RNN 110, belong to a group experiencing the same or similar interference, belong to a group having the same or similar receiver sensitivity, or belong to a group being served by a RNN having the same or similar transmitter power, just to mention some examples.

Action 601 relates to Action 301 previously described.

Action 602

The RNN 110 transmits, to the wireless device 130, information relating to the first resource for CSI measurement.

The RNN 110 may transmit the information to the wireless device 130 using one or more of a RRC protocol, MAC, and DCI as described above.

Action 602 relates to Action 302 previously described.

Action 603

The RNN 110 determines an indication to determine a second resource for CSI measurement. The indication relates to the first resource for CSI measurement. Further, the second resource for CSI measurement is different from the first resource for CSI measurement.

For example and as previously mentioned, the second resource for CSI measurement may be a second CSI RS measurement resource, or a second CSI IM resource.

In some embodiments, the first and second resources for CSI measurement is a respective first and second CSI RS measurement resource.

In some alternative embodiments, the first and second resources for CSI measurement is a respective first and second CSI IM resource.

In some embodiments, the RNN 110 determines the indication to determine the second resource for CSI measurement by firstly determine the second resource for CSI measurement to correspond to one or more of: an CSI resource determined as being used in an interfering RNN 120; an available second resource for CSI measurement; an CSI resource determined as not being used by one or more other wireless devices 132,134; and an CSI resource determined to be used by one or more other wireless devices 132,134; and by secondly determine the indication to determine the second resource for CSI measurement based on the determined second resource for CSI measurement and on one or more of: a number of antennas associated with the RNN 110; a radio channel characteristic and an interference characteristic.

In some embodiments, the RNN 110 determines the indication to comprise information relating to one or more PRBs to be used by the wireless device 130 when determining the second resource.

The second resource for CSI measurement may be a frequency sub-sampling, a time sub-sampling, a code sub-sampling, a time offset and/or a frequency offset of the first resource for CSI measurement.

Further, the second resource for CSI measurement may be a combination of two or more first resources for CSI measurements.

Action 603 relates to Action 303 previously described.

Action 604

The RNN 110 transmits, to the wireless device 130, the indication to determine the second resource for CSI measurement.

Further, the RNN 100 may transmit the indication using one or more of a RRC protocol, MAC, and DCI as previously described.

Action 604 relates to Action 304 previously described.

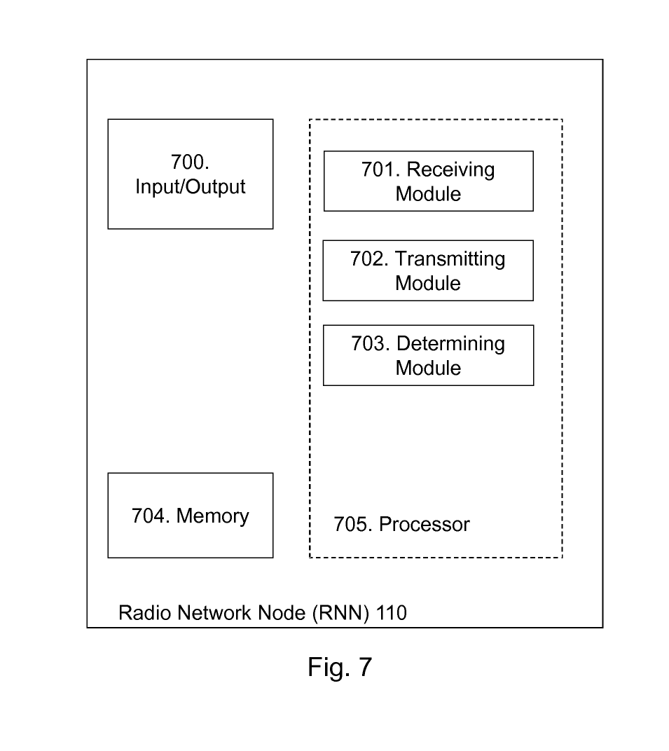

To perform the methods for assisting the wireless device 130 in performing CSI measurements, the RNN 110 may comprise an arrangement depicted in FIG. 7. As previously mentioned, the wireless device 130 and the RNN 110 serving the wireless device 130 are configured to operate in a wireless communications system 100.

In some embodiments, the RNN 110 comprises an input and/or output interface 700 configured to communicate with one or more wireless devices, such as the wireless device 130, one or more other radio nodes, such as the interfering RNN 120, and/or one or more other network nodes. The input and/or output interface 700 may comprise a wireless receiver (not shown) and a wireless transmitter (not shown).

The RNN 110 may be configured to receive, e.g. by means of a receiving module 701 configured to receive, from the wireless device 130, the result of a performed CSI measurement and/or information relating to such result. The receiving module 701 may be implemented by the wireless receiver or a processor 706 of the RNN 110. The processor 706 will be described in more detail below.

The RNN 110 is configured to transmit, e.g. by means of a transmitting module 702 configured to transmit, to the wireless device 130, information relating to a first resource for CSI measurement.

The transmitting module 702 may be the wireless transmitter (not shown) or the processor 705 of the RNN 110.

Further, the RNN 110 is configured to transmit, to the wireless device 130, an indication to determine a second resource for CSI measurement.

For example and as previously mentioned, the second resource for CSI measurement may be a second CSI RS measurement resource, or a second CSI IM resource.

In some embodiments, the first and second resources for CSI measurement is a respective first and second CSI RS measurement resource.

In some alternative embodiments, the first and second resources for CSI measurement is a respective first and second CSI IM resource.

The second resource for CSI measurement may be a frequency sub-sampling, a time sub-sampling, a code sub-sampling, a time offset and/or a frequency offset of the first resource for CSI measurement.

Further, the second resource for CSI measurement may be a combination of two or more first resources for CSI measurements.

The RNN 110 is configured to determine, e.g. by means of a determining module 703 configured to determine, the first resource for CSI measurement.

The determining module 703 may be implemented by the processor 705 of the RNN 110.

Further, the RNN 110 is configured to determine the indication to determine the second resource for CSI measurement, which second resource for CSI measurement is different from the first resource for CSI measurement.

In some embodiments, the RNN 110 is configured to determine the first resource for CSI measurement by further being configured to determine the first resource for CSI measurement to correspond to one or more of an CSI resource determined as being used in an interfering RNN 120, an available first resource for CSI measurement; an CSI resource determined as not being used by one or more other wireless devices 132,134; and an CSI resource determined to be used by one or more other wireless devices 132,134.

In some embodiments, the RNN 110 is configured to determine the indication to determine the second resource for CSI measurement by further being configured to firstly determine the second resource for CSI measurement to correspond to one or more of: an CSI resource determined as being used in an interfering RNN 120; an available second resource for CSI measurement; an CSI resource determined as not being used by one or more other wireless devices 132,134; and an CSI resource determined to be used by one or more other wireless devices 132,134; and secondly determine the indication to determine the second resource for CSI measurement based on the determined second resource for CSI measurement and one or more of a number of antennas associated with the RNN 110, a radio channel characteristic and an interference characteristic.

In some embodiments, the RNN 110 is configured to determine the indication to determine the second resource for CSI measurement by further being configured to determine the indication to comprise information relating to one or more PRBs to be used by the wireless device 130 when determining the second resource.

In some embodiments, the RNN 110 is configured to determine the second resource for CSI measurement as a frequency sub-sampling, a time sub-sampling, a code sub-sampling, a time offset and/or a frequency offset of the first resource for CSI measurement.

Further, in some embodiments, the RNN 110 is configured to determine the second resource for CSI measurement as a combination of two or more first resources for CSI measurements.

The RNN 110 may also comprise means for storing data. In some embodiments, the RNN 110 comprises a memory 705 configured to store the data. The data may be processed or non-processed data and/or information relating thereto. The memory 705 may comprise one or more memory units. Further, the memory 705 may be a computer data storage or a semiconductor memory such as a computer memory, a read-only memory, a volatile memory or a non-volatile memory. The memory is arranged to be used to store obtained information, data, configurations, schedulings, and applications etc. to perform the methods herein when being executed in the RNN 110.

Embodiments herein for assisting a wireless device 130 in performing CSI measurements may be implemented through one or more processors, such as the processor 705 in the arrangement depicted in FIG. 7, together with computer program code for performing the functions and/or method actions of embodiments herein. The program code mentioned above may also be provided as a computer program product, for instance in the form of a data carrier carrying computer program code for performing the embodiments herein when being loaded into the RNN 110. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the RNN 110.

Those skilled in the art will also appreciate that the receiving module 701, the transmitting module 702, and the determining module 703 above may refer to a combination of analog and digital circuits, and/or one or more processors configured with software and/or firmware, e.g. stored in the memory, that when executed by the one or more processors such as the processors in the RNN 110 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### EXEMPLIFYING EMBODIMENTS

Some exemplifying embodiments will now be described with reference to the action mentioned above.

### I. Exemplifying Embodiments: CSI-RS Resource for LTE Evolution

Some exemplifying embodiments are targeting the evolution of LTE. Hence, a fixed location of the CSI-RS in a subframe comprising CSI-RS may be assumed as per the current 3GPP specifications Rel-11 (3GPP TS 36.331, “Evolved Universal Terrestrial Radio Access (E-UTRA); Radio Resource Control (RRC) protocol specification”, Version 11).

The RNN 110, e.g. an eNB, implementing some embodiments described herein will use the same CSI-RS configuration index for one or more beams. For example, this relates to Actions 301 and 601 described above, wherein the RNN 110 determines a first resource for CSI measurement.

In some exemplifying embodiments, the wireless device 130, e.g. a UE, is configured with one or more CSI measurement processes for each beam the RNN 110 desires to receive CSI feedback for. For example, this relates to Actions 302, 401 and 602 described above, wherein the RNN 110 transmits and the wireless device 130 receives information relating the first resource for CSI measurement.

In addition to the Rel-11 CSI process configuration, some embodiments herein specify in addition to the CSI-RS configuration index, also a PRB bitmap specifying which PRBs that are associated with that very CSI process. Thus, this may for example relate to Actions 301 and 601 described above, wherein the RNN 110 determines a first resource for CSI measurement. Further, it relates to Actions 303 and 603, wherein the RNN 110 determines the indication and to Actions 304 and 604, wherein the RNN 110 transmits the indication, e.g. the PRB bitmap. Furthermore, it relates to Actions 305, 402 and 403, wherein the wireless device 120 receives the indication and determines the second resource.

In some exemplifying embodiments, the Rel-11 CSI process configuration information element in 3GPP specifications Rel-11 Section 6.3.2 may be extended, and some embodiments herein will comprise the CSI process configuration information element CSI_process-rxx:

| CSI-Process-rxx ::= | | SEQUENCE { |
|---|---|---|
| | csi-ProcessId-r11 | CSI-ProcessId-r11, |
| | csi-RS-ConfigNZPId-r11 | CSI-RS-ConfigNZPId-r11, |

| | |
|---|---|
| csi-RS-PRB-bitmap-rxx | BIT STRING |

| csi-IM-ConfigId-r11 | CSI-IM-ConfigId-r11, | |
|---|---|---|
| p-C-AndCBSRList-r11 | SEQUENCE (SIZE (1..2)) OF P-C-AndCBSR-r11, | |
| cqi-ReportBothProc-r11 | CQI-ReportBothProc-r11 | OPTIONAL,-- Need OR |

| | |
|---|---|
| cqi-ReportPeriodicProcId-r11 INTEGER (0..maxCQI-ProcExt-r11) | OPTIONAL,-- Need OR |
| cqi-ReportAperiodicProc-r11 CQI-ReportAperiodicProc-r11 | OPTIONAL,-- Need OR |

...

}
P-C-AndCBSR-r11 ::= SEQUENCE {

| | |
|---|---|
| p-C-r11 | INTEGER (−8..15), |
| codebookSubsetRestriction-r11 | BIT STRING |

}
-- ASN1STOP

The ‘csi-RS-PRB-bitmap-rxx’-field above specifies the PRBs that define the CSI-RS measurement resource for the CSI process. Thus, the information comprised in the information element, e.g. the CSI process configuration information element mentioned above, relates to the first resource for CSI measurement if the csi-RS-PRB-bitmap-rxx indicate all PRBs, but relates to the second resource for CSI measurement if csi-RS-PRB-bitmap-rxx indicate a subset of the PRBs, e.g. a proper subset of the PRBs. For some exemplifying embodiments, the CSI-IM resource comprises all PBRs in the frequency band.

FIGS. 8A and 8B schematically illustrates a first exemplifying PRB bitmap CSI measurement resource configuration comprising an first resource and second resource for CSI measurement respectively. In FIGS. 8A and 8B an example of how the Rel-11 CSI-RS measurement resource with configuration identity 8 may be divided into two CSI-RS measurement resources is schematically illustrated.

In some embodiments, the configuration information element for the CSI process comprises, additionally or alternatively, a ‘csi-IM-PRB-bitmap-rxx’-field specifying explicitly which PRBs that define the CSI-IM measurement resource for the CSI process. As for the csi-RS-PRB-bitmap-rxx, if csi-IM-PRB-bitmap-rxx indicate a subset of the PRBs, then the CSI-IM measurement resource is the second resource for CSI measurement. Sometimes herein “the configuration information element for the CSI process” is referred to as “the CSI process configuration information element”. For example, this may relate to Actions 301 and 601 described above, wherein the RNN 110 determines a first resource for CSI measurement. Further, it may also relate to Actions 302-305, 403, and 602-604. The CSI process configuration information element is sent to the wireless device 130, cf. Actions 302 and 304. The wireless device 130 receives the configuration and obtains the second resource for CSI measurement, e.g. the CSI-RS measurement resource or CSI-IM resource, cf. Action 305. Further, when the wireless device 130 uses, e.g. measures on the second resource it performs Action 306. This example shows that the Actions 302 and 304 may be done using same the message. However, in some embodiments, the Actions 301 and 302 are done first, e.g. the PRB bit indicates all PRBs, then later the Actions 303 and 304 are done.

In some embodiments, the PRB bitmap may be indicated in the non-zero power CSI-RS configuration information element ‘CSI-RS-ConfigNZP-rxx’ as:

| CSI-RS-ConfigNZP-rxx ::=SEQUENCE { | |
|---|---|
| csi-RS-ConfigNZPId-r11 | CSI-RS-ConfigNZPId-r11, |
| antennaPortsCount-r11 | ENUMERATED {an1, an2, an4, an8}, |
| resourceConfig-r11 | INTEGER (0..31), |
| subframeConfig-r11 | INTEGER (0..154), |
| csi-RS-PRB-bitmap-Config-rxx | INTEGER (0..X), |
| scramblingIdentity-r11 | INTEGER (0..503), |

| | |
|---|---|
| qcI-CRS-Info-r11 | SEQUENCE { |

| | |
|---|---|
| qcI-ScramblingIdentity-r11 | INTEGER (0..503), |
| crs-PortsCount-r11 | ENUMERATED {n1, n2, n4, spare1}, |
| mbsfn-SubframeConfigList-r11 | CHOICE { |

| | |
|---|---|
| release | NULL, |
| setup | SEQUENCE { |

| | |
|---|---|
| subframeConfigList | MBSFN-SubframeConfigList |

}

| | |
|---|---|
| } | OPTIONAL-- Need ON |

| | |
|---|---|
| } | OPTIONAL,-- Need OR |

...

}
-- ASN1STOP

For this exemplifying embodiment the PBR bitmap is indicated by an enumeration value of possible bitmaps. The possible bitmaps may be assigned an enumeration value in the specification. For example, an enumeration value of 0 may indicate bitmap#0, and an enumeration value of 1 may indicate bitmap#1, etc. This may relate to Actions 301 and 601 described above, wherein the RNN 110 determines a first resource for CSI measurement.

In some other embodiments, the PBR bitmap is explicitly indicated as a bit string. This may relate to Actions 301 and 601 described above, wherein the RNN 110 determines a first resource for CSI measurement.

In some further embodiments, the used PRB bitmaps are configured as:

| | |
|---|---|
| CSI-RS-ConfigPRBBitmap-rxx ::= | SEQUENCE { |

| csi-RS-ConfigPRBBitmapId-rxx CSI-RS-ConfigPRBBitmapId-rxx, | |
|---|---|
| prb-bitmap | BIT STRING |

...

}
-- ASN1STOP

In such embodiments, the ‘csi-RS-PRB-bitmap-rxx’-field described above may be replaced by the ‘csi-RS-ConfigPRBBitmapld-rxx’-field in the CSI process configuration information element above. Thus, this may for example relate to Actions 301 and 601 described above, wherein the RNN 110 determines a first resource for CSI measurement.

In some embodiments, the PRB bitmap is configured with a periodicity and an offset, thereby providing a subsampling in time rather than in frequency.

In some embodiments, an overlay code is used instead of frequency and/or time subsampling. A benefit of a code spreading is that a processing gain may be obtained when detecting the reference signal, e.g. the modulated reference symbols. In such embodiments, instead of a frequency subset, a spreading code is signaled in the configuration. In some embodiments, both a frequency subset and a spreading code may be applied.

### II. Exemplifying Embodiments: Frequency Sub-Sampling for a Grid-of-Beams Solution

In this section, some embodiments will be exemplified using a heterogeneous communications network (HetNet) deployment. A HetNet often uses multiple types of access nodes. For example, macrocells, and small cells such as picocells, and/or femtocells, may be used in order to offer wireless coverage in an environment with a wide variety of wireless coverage zones, ranging from an open outdoor environment to office buildings, homes, and underground areas. Thus, a HetNet may be seen as a wireless communications network, e.g. the wireless communications system 100, with complex interoperation between macrocell, small cell, and in some cases WiFi network elements used together to provide a mosaic of coverage, with handoff capability between network elements. This may be an example of what may be a typical initial deployment for a 5G system utilizing large antenna arrays by transmitting a grid of beams from each antenna panel. This example is quite close to a traditional 3-sector deployment with the difference that one beam per sector is modified such that each sector has a grid of a number of beams, e.g. 8 beams per sector, which 8 beams will result in a 24 sector type deployment. Since each of these 24 beams is very narrow, e.g. with approximately 15 degrees coverage each, they will spatially filter the radio channel giving a quite frequency flat channel for each beam direction. Pico base stations serving picocells, have in this example some slightly less advanced antenna panels with e.g. two beam-directions.

In some embodiments, the wireless device 130 connected to the RNN 110, e.g. the macro base station, is configured with a frequency sub-sampling value of eight (8) for CSI-RS, e.g. the wireless device 130 will make a measurement on every eight frequency elements. For example, this relates to Actions 301 and 601 described above, wherein the RNN 110 determines a first resource for CSI measurement, and to Actions 302, 401 and 602 described above, wherein the RNN 110 transmits and the wireless device 130 receives information relating the first resource for CSI measurement. This value eight (8) maps to that the RNN 110 sends on the corresponding elements with each of the 8 beams, e.g. the pre-coders, mentioned above.

In some embodiments, wherein the wireless device 130 is connected to the RNN 110 being a pico base station, the wireless device 130 may be configured with a factor of 2 for the CSI-RS measurements but also with a factor of 8 for some of the CSI-IM measurements enabling the correct measurements of interference per beam from one or more interfering RNN 120, e.g. one or more macro base-stations. Thanks to embodiments herein, the wireless communications system 100 is now able to efficiently measure the 8 beams enabling advanced features like Coordinated MultiPoint (CoMP) with minimal additional overhead.

### III. Exemplifying Embodiments: Extending the Number of Antenna Ports

In some exemplifying embodiments, the number of antenna ports supported in and/or by the wireless communications system 100 may be increased.

For example, it may be assumed that a future release of the wireless communications system 100, herein referred to as Release X (Rel-X), supports up to p ports, wherein p is larger than e.g. 8, which is the maximum number of ports supported by Rel-12. Further, it may be assumed that the wireless communication system 100 of Rel-X has implemented embodiments herein in such a way that a set of CSI configuration identities is defined in an CSI measurement resource. For example, this relates to Actions 301 and 601 described above, wherein the RNN 110 determines a first resource for CSI measurement. The CSI measurement resource may be assumed to comprise a minimum set of resource elements required to define a minimum measurement resource for each of the CSI configuration identities. For example, Rel-X may define a CSI measurement resource to be the resource elements within a single PRB defined for CSI in Rel-12 (3GPP TS 36.211, version 12, Section 6.10.5.2). Recall that for Rel-12 the CSI measurement resource covers all PRBs.

Rel-12 has defined sets of CS configuration identities for up to 8 ports, and in some embodiments, Rel-X supports up to 8 ports and a CSI measurement resource is defined as the resource elements within a PRB for CSI measurement according to Rel-12. In such embodiments, the wireless device 130 is configured with a CSI measurement resource comprising a CSI configuration identity, a list or bitmap of PRBs and a list of ports that defines the measurement resource. For example, this relates to actions 302, 401 and 602 described above, wherein the RNN 110 transmits and the wireless device 130 receives information relating the first resource for CSI measurement. A non-zero power configuration may utilize the structure below:

```
CSI-RS-ConfigNZP-rXX = SEQUENCE {
  csi-RS-ConfigNZPId-rXX
  SEQUENCE {
```

| | |
|---|---|
| antennaPortList | SEQUENCE{ AntennaPort }, |

| | |
|---|---|
| resourceConfig-rXX | INTEGER (0..X), |
| subframeConfig-rXX | INTEGER (0..154), |

| | |
|---|---|
| prbBitmap | BIT STRING |

}

}
-- ASN1STOP

In Rel-12 the 8 ports for CSI-RS are numbered 15-22 and an example configuration for Rel-X is given below:

```
CSI-RS-ConfigNZP-rXX = SEQUENCE {
  csi-RS-ConfigNZPId-rXX = 1
  SEQUENCE {
```

```
{
  antennaPortList = {15,16,17,18,19,20,21,22},
  resourceConfig-rXX = 0,
  subframeConfig-rXX = 0,
  prbBitmap=”ones(1,#PRBS)”
  },
```

}
-- ASN1STOP

The wireless device 130 is configured with CSI-RS measurement resource identity, i.e., csi-RS-ConfigNZPld-rXX=1, which may be associated with one or more CSI processes or any other future measurement, e.g., a Reference Signal Received Power (RSRP) measurement. The CSI-RS configuration identity determined by “resourceConfig-rXX=0” and in this example the Subframe (SF) period and offset is determined by “subframeConfig-rXX=0” and the measurement resource is defined in all PRBs in the frequency band. The antennaPortList specifies the list of antenna ports associated with this measurement resource. Here it is assumed that each entry in the antenna port list is associated with a pre-defined mapping to one or more resource elements. For example, the first entry maps to the resource elements for port number 15 in Rel-12, second element to the resource elements for port number 16 in Rel-12, and so on. This means that the above configuration coincides with a Rel-12 measurement resource for CSI-RS configuration identity 0.

Assume that another future release of the wireless communications system 100, herein called Release Y (Rel-Y) desires to extend the Rel-X support to 16 ports. Let the additional 8 ports be numerated 31-38. For example, this relates to Actions 303 and 603 described above, wherein the RNN 110 determines an indication to determine a second resource for CSI measurement. An example configuration for Rel-Y is given below:

CSI-RS-ConfigNZP-rXX = SEQUENCE {

csi-RS-ConfigNZPId-rXX = 1
SEQUENCE {

```
{
  antennaPortList = {15,16,17,18,19,20,21,22}
  resourceConfig-rXX = 0
  subframeConfig-rXX = 0
  prbBitmap=”bitmap for even PRBs”
},
{
  antennaPortList = {31,32,33,34,35,36,37,38}
  resourceConfig-rXX = 0
  subframeConfig-rXX = 0
  prbBitmap=”bitmap for odd PRBs
  }
```

}
}
-- ASN1STOP

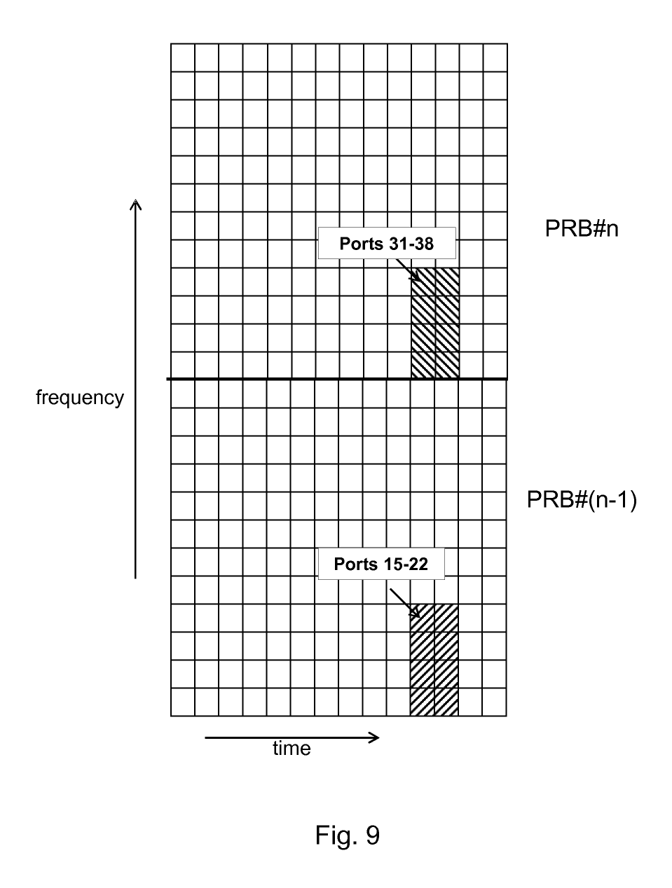

This configuration would define a 16 port measurement resource for a Rel-Y wireless device 130 utilizing a Rel-X structure. This may relate to actions 304, 402 and 604 described above, wherein the RNN 110 transmits and the wireless device 130 receives the indication to determine the second resource for CSI measurement. Thus, without a need to change the RRC protocol specification. As exemplified, in even PRBs the wireless device 130 performs measurements for ports 15-22 and in odd PRBs the wireless device 130 performs measurements for the remaining ports 31-38. Recall that port 31 maps to the Rel-12 resource elements for port 15, port 32 to the Rel-12 resource elements for port 16, and so on. The resulting CSI-RS measurement resource is illustrated in FIG. 9, which figure schematically illustrates a second exemplifying PRB bitmap CSI measurement resource configuration. This relates e.g. to the Actions 305 and 403 described above wherein the wireless device 130 determines the second resource for CSI measurement.

For a more general exemplifying embodiment, an example configuration structure is given below:

```
CSI-RS-ConfigNZP-rXX = SEQUENCE {
  csi-RS-ConfigNZPId-rXX
  SEQUENCE {
```

| | |
|---|---|
| antennaPortList | SEQUENCE{ AntennaPort }, |

| | |
|---|---|
| resourceConfig-rXX | INTEGER (0..X), |
| subframeConfig-rXX | INTEGER (0..154), |
| subframeBitmap | BIT STRING, |

| | |
|---|---|
| prbBitmap | BIT STRING |

}

}
-- ASN1STOP

Additionally, the configuration given above specifies a ‘subframeBitmap’ defining which OFDM symbols within the subframe that are utilized for the measurement resource. An example 16 port configuration is given below:

```
CSI-RS-ConfigNZP-rXX = SEQUENCE {
  csi-RS-ConfigNZPId-rXX = 1
  SEQUENCE {
```

{

antennaPortList = {15,16,17,18,19,20,21,22}
resourceConfig-rXX = 0
subframeConfig-rXX = 0
subframeBitmap=00000000001100
prbBitmap=ones(1,N_PRB)

},
{

antennaPortList = {31,32,33,34,35,36,37,38}
resourceConfig-rXX = 0
subframeConfig-rXX = 0
subframeBitmap=00000000000011
prbBitmap=ones(1,N_PRB)

}

}
}
-- ASN1STOP

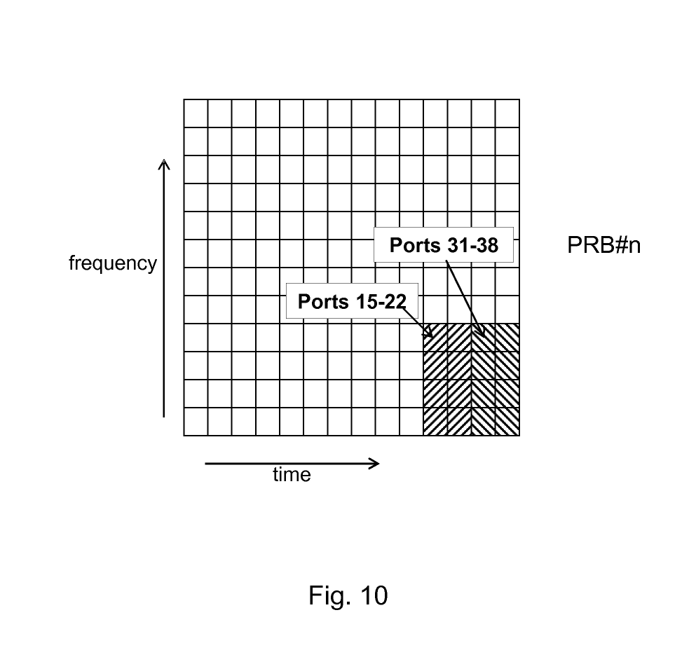

Ports 15-22 are in the example give above measured in the 11th and 12th OFDM symbols and in all PRBs, while ports 31-38 are measured in the 13th and 14th OFDM symbols. The port to resource element mapping for the 13th and 14th OFDM symbols is assumed to be only time-shifted 2 OFDM symbols to the right in this example. Hence, port and port 31 have the same sub-carrier(s), but different OFDM symbols. The resulting CSI-RS measurement resource is illustrated in FIG. 10. Thus, FIG. 10 schematically illustrates a third exemplifying PRB bitmap CSI measurement resource configuration.

In some embodiments, the density in frequency of the different antenna ports may be different. As an example, the first set of ports {15, . . . 22} may be present in every PRB while the second set of ports {31, . . . 38} only is configured in a subset of the PRBs. This has the benefit that legacy users may be scheduled in resource blocks that does not have the second set of ports while new users may be scheduled on any resource block.

When using the word “comprise” or “comprising” it shall be interpreted as non-limiting, i.e. meaning “consist at least of”. Further, when using the word “a”, or “an” herein it should be interpreted as “at least one”, “one or more”, etc.

The embodiments herein are not limited to the above described preferred embodiments. Various alternatives, modifications and equivalents may be used. Therefore, the above embodiments should not be taken as limiting the scope of the invention, which is defined by the appended claims.

### Abbreviations

3GPP Third Generation Partnership Project

eNB Enhanced NodeB

CQI Channel-Quality Indicator

CRS Cell-Specific Reference Symbol

CSI Channel-State Information

CSI-IM CSI Interference Measurement

CSI-RS CSI Reference Symbol

LTE Long Term Evolution

MIMO Multiple Input Multiple Output

PMI Pre-coding Matrix Indicator

PRB Physical Resource Block

RI Rank Indicator

RRC Radio Resource Control

TM Transmission Mode

UE User Equipment

1-30. (canceled)

31. A method, performed by a wireless device, for performing Channel-State Information (CSI) measurements, wherein the wireless device and a Radio Network Node (RNN) serving the wireless device are operating in a wireless communications system, the method comprising:
receiving, from the RNN, information relating to a first resource for CSI measurement;
receiving, from the RNN, an indication to determine a second resource for CSI measurement, which indication relates to the first resource for CSI measurement;
determining the second resource for CSI measurement based on the information relating to the first resource and on information comprised in the indication, which second resource for CSI measurement is different from the first resource for CSI measurement; and
performing an CSI measurement on the second resource.

32. The method of claim 31, wherein the determining the second resource for CSI measurement comprises determining the second resource for CSI measurement as a frequency sub-sampling, a time sub-sampling, a code sub-sampling, a time offset and/or a frequency offset of the first resource for CSI measurement.

33. The method of claim 31, wherein the determining the second resource for CSI measurement based comprises determining the second resource for CSI measurement as a combination of two or more first resources for CSI measurements.

34. The method of claim 31, wherein the determining the second resource for CSI measurement comprises determining the second resource for CSI measurement based on information relating to one or more Physical Resource Blocks, which information is comprised in the received indication.

35. The method of claim 31, wherein the first and second resources for CSI measurement are respective first and second CSI Reference Symbol measurement resources.

36. The method of claim 31, wherein the first and second resources for CSI measurement are respective first and second CSI Interference Measurement resources.

37. A wireless device for performing Channel-State Information (CSI) measurements, wherein the wireless device and a Radio Network Node (RNN) serving the wireless device are configured to operate in a wireless communications system, wherein the wireless device comprises
processing circuitry;
memory containing instructions executable by the processing circuitry whereby the wireless device is operative to:
receive, from the RNN, information relating to a first resource for CSI measurement;
receive, from the RNN, an indication to determine a second resource for CSI measurement, which indication relates to the first resource for CSI measurement;
determine the second resource for CSI measurement based on the information relating to the first resource and on information comprised in the indication, which second resource for CSI measurement is different from the first resource for CSI measurement; and
perform an CSI measurement on the second resource.

38. The wireless device of claim 37, wherein the instructions are such that the wireless device is operative to determine the second resource for CSI measurement as a frequency sub-sampling, a time sub-sampling, a code sub-sampling, a time offset and/or a frequency offset of the first resource for CSI measurement.

39. The wireless device of claim 37, wherein the instructions are such that the wireless device is operative to determine the second resource for CSI measurement as a combination of two or more first resources for CSI measurements.

40. A method, performed by a Radio Network Node (RNN), for assisting a wireless device in performing Channel State Information (CSI) measurement, wherein the wireless device and the RNN serving the wireless device are operating in a wireless communications system, the method comprising:
determining a first resource for CSI measurement;
transmitting, to the wireless device, information relating to the first resource for CSI measurement;
determining an indication to determine a second resource for CSI measurement, which indication relates to the first resource for CSI measurement and which second resource for CSI measurement is different from the first resource for CSI measurement; and
transmitting, to the wireless device, the indication to determine the second resource for CSI measurement.

41. The method of claim 40, wherein the determining the first resource for CSI measurement comprises determining the first resource for CSI measurement to correspond to one or more of:
a CSI resource determined as being used in an interfering RNN;
an available first resource for CSI measurement;
a CSI resource determined as not being used by one or more other wireless devices; and
a CSI resource determined to be used by one or more other wireless devices.

42. The method of claim 40, wherein the determining the indication to determine the second resource for CSI measurement comprises:
determining the second resource for CSI measurement to correspond to one or more of:
a CSI resource determined as being used in an interfering RNN;
an available second resource for CSI measurement;
a CSI resource determined as not being used by one or more other wireless devices; and
a CSI resource determined to be used by one or more other wireless devices;
determining the indication to determine the second resource for CSI measurement based on the determined second resource for CSI measurement and on one or more of:
a number of antennas associated with the RNN;
a radio channel characteristic; and
an interference characteristic.

43. The method of claim 40, wherein the determining the indication to determine the second resource for CSI measurement comprises determining the indication to comprise information relating to one or more Physical Resource Blocks to be used by the wireless device when determining the second resource.

44. The method of claim 40, wherein the first and second resources for CSI measurement are respective first and second CSI Reference Symbol measurement resources.

45. The method of claim 40, wherein the first and second resources for CSI measurement are respective first and second CSI Interference Measurement resources.

46. The method of claim 40, wherein the second resource for CSI measurement is a frequency sub-sampling, a time sub-sampling, a code sub-sampling, a time offset and/or a frequency offset of the first resource for CSI measurement.

47. The method of claim 40, wherein the second resource for CSI measurement is a combination of two or more first resources for CSI measurements.

48. A Radio Network Node (RNN) for assisting a wireless device in performing Channel State Information (CSI) measurement, wherein the wireless device and the RNN serving the wireless device are configured to operate in a wireless communications system, wherein the RNN comprises
processing circuitry;
memory containing instructions executable by the processing circuitry whereby the RNN is operative to:
determine a first resource for CSI measurement;
transmit, to the wireless device, information relating to the first resource for CSI measurement;
determine an indication to determine a second resource for CSI measurement, which indication relates to the first resource for CSI measurement and which second resource for CSI measurement is different from the first resource for CSI measurement; and
transmit, to the wireless device, the indication to determine the second resource for CSI measurement.

49. The RNN of claim 48, wherein the instructions are such that the RNN is operative to determine the first resource for CSI measurement to correspond to one or more of:
a CSI resource determined as being used in an interfering RNN;
an available first resource for CSI measurement;
a CSI resource determined as not being used by one or more other wireless devices; and
a CSI resource determined to be used by one or more other wireless devices.

50. The RNN of claim 48, wherein the instructions are such that the RNN is operative to determine the second resource for CSI measurement by:
determining the second resource for CSI measurement to correspond to one or more of:
a CSI resource determined as being used in an interfering RNN;
an available second resource for CSI measurement;
a CSI resource determined as not being used by one or more other wireless devices; and
a CSI resource determined to be used by one or more other wireless devices; and
determining the indication to determine the second resource for CSI measurement based on the determined second resource for CSI measurement and one or more of:
a number of antennas associated with the RNN;
a radio channel characteristic; and
an interference characteristic.
